(19) United States
(12) Patent Application Publication
(10) Pub. No.: US 2014/0157401 A1
(43) Pub. Date: Jun. 5, 2014

(54) Method of Dynamically Adjusting an Authentication Sensor

(71) Applicant: MOTOROLA MOBILITY LLC, Libertyville, IL (US)

(72) Inventors: Rachid M. Alameh, Crystal Lake, IL (US); Jiri Slaby, Buffalo Grove, IL (US)

(73) Assignee: MOTOROLA MOBILITY LLC, Libertyville, IL (US)

(21) Appl. No.: 13/726,750

(22) Filed: Dec. 26, 2012

Related U.S. Application Data
(60) Provisional application No. 61/731,836, filed on Nov. 30, 2012.

(51) Int. Cl. G06F 21/45

(52) U.S. Cl. CPC G06F 21/45
USPC 726/17

(57) ABSTRACT

A method is disclosed herein for employing detected device context, user history, and inferred identity to cause biometric sensors identification levels to automatically adjust to reduce device access time, computational complexity, and power.

Priority is taken from Provisional Application 61/731,836 filed on Nov. 30, 2012 by Alameh et al. and incorporated herein in its entirety by reference.

### FIELD OF INVENTION

Disclosed herein is an electronic device having an authentication means for identifying an authorized user. More particularly an electronic device automatically adjusts the security levels for the electronic device.

### BACKGROUND

Electronic devices having computing or processor capability may employ several authentication means for identifying an authorized user of the electronic device. Some possible authentication means include passwords, predetermined gestures, facial image recognition, voice patterns, and fingerprint recognition, for example. Each of the listed authentication means have their strengths and weaknesses for either reliability or implementation.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates, by way of example, an electronic computing device having multiple means for authentication.

FIG. 2 illustrates example parameters for determining security levels for the electronic computing device of FIG. 1.

FIG. 3A-3D illustrates multiple selected security levels for the electronic computing device of FIG. 1.

FIG. 4 illustrates an example flowchart for one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method is disclosed herein for employing detected device context, user history, and inferred identity to cause biometric sensors identification levels to automatically adjust to reduce device access time, computational complexity, and power.

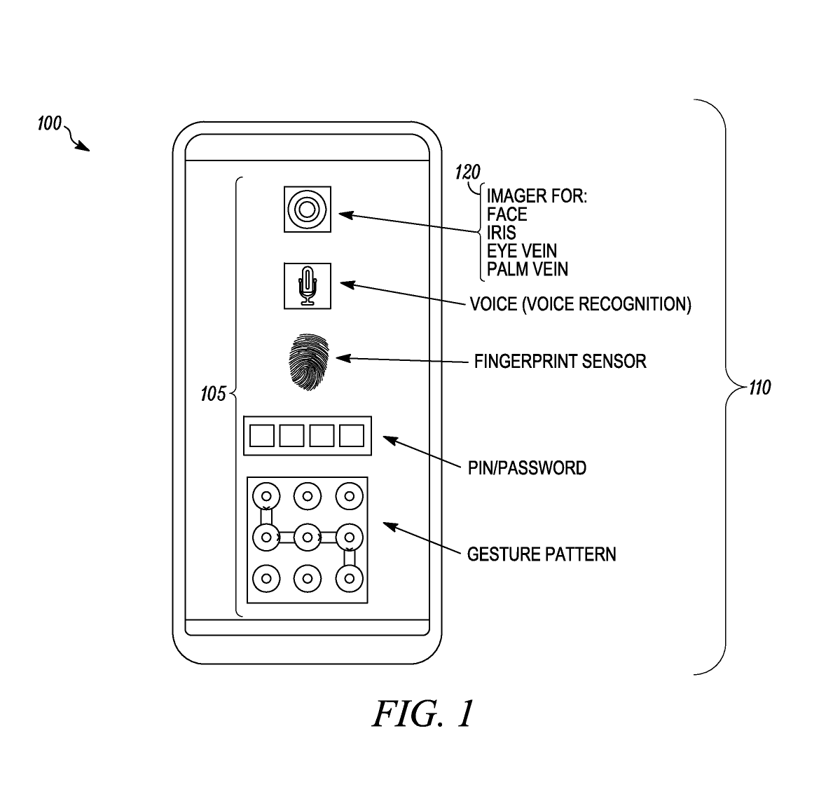

Referring to FIG. 1, an electronic computing device 100 is shown. Electronic computing device 100 may be contemplated as a smartphone, tablet computer, or a wearable computer, for example. Electronic computing device 100 may include a housing for containing electrical components such as a display, a processor, a power module, a context sensor, and an authentication sensor. Each electrical component may be one of several of their type, yet are discussed herein singularly for greater clarity of understanding. In addition, other electrical components such as transceivers, analog-digital converters, and memory storage components may also be housed within electronic computing device 100.

On the display of electronic computing device 100 can be several icons 105 for indicating one or more authentication means that will enable identifying a user of the electronic computing device 100 for permitting access to secured information within the electronic computing device 100. The icons 105 may indicate an imaging application, a microphone application, a fingerprint sensor application, a password application, or a gesture pattern application that may be employed as an authentication application. Several example types of authentication means 110 are shown in FIG. 1 for coordination with the applications depicted by icons 105. These authorization means 110 may include imaging recognition means 120 that can be configured to recognize facial features, including irises and eye veins. The imaging recognition means may also be used for recognizing palm veins on a user's hands. Other authorization means 110 may include voice recognition, fingerprint sensors, touch sensors for recognizing PIN passwords and/or gesture patterns. Some gestures may also be detected off-glass and therefore without touching the display glass.

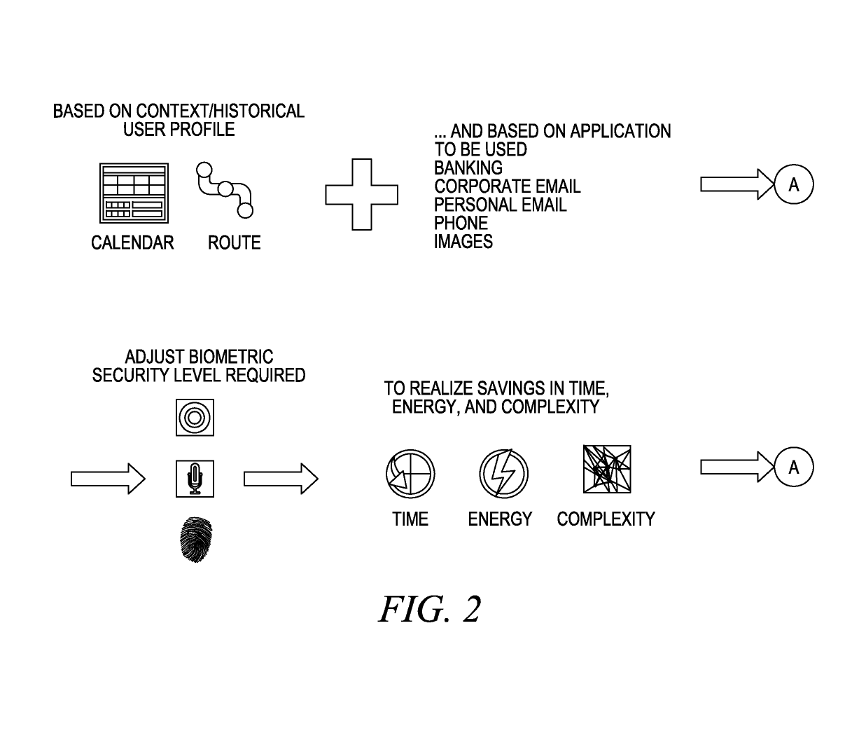

Referring to FIG. 2, electronic computing device 100 may be configured with multiple sensors for sensing biometrics corresponding to a user of the electronic computing device 100 and contextual information also corresponding to the user and his activities. The biometrics sensor identification level may be adjusted based on information from other sensors providing information and patterns about a user of the electronic computing device 100. The adjustment of the biometrics sensor identification level further includes prioritizing a subset of biometric sensors and also eliminating inadequate sensors based on device context. Some example contextual types include location as measured by a sensor configured to receive location data. The location data may be correlated to GPS, Wi-Fi, indoor navigation, triangulation, and barometer reading, for example. Data related to a route traveled may be determined by a sensor configured to determine GPS and cell triangulation, for example.

Voice data may be sensed by a voice recognition sensor configured for voice patterns, for example; while the ambient environment may be determined from an imaging sensor. An IR LED sensor may be combined with the imaging sensor for determining uniqueness of a user's ear, face, iris recognition, etc., to eliminate, or minimize, impact of ambient light. Other sensors such as a proximity sensor, an accelerometer, a gyroscope, or an ambient light sensor (ALS) for visible light can be utilized for detecting whether the electronic computing device 100 is within a pocket or purse, for example. A color sensor may be employed to further examine if the device can improve owner detection via a facial imager.

An accelerometer or gyroscope may be used for gait detection and may be combined with environment such as hiking in the woods versus walking in a mall parking lot. The same sensors may be used for determining tremble detection of a user's hand.

Additional sensor may enable grip detection via a capacitive, thermal, or pressure sensor to identify how the phone is held and assess user action. Likewise, a smell sensor may be employed for determining contextual activity and environment.

FIG. 2 also illustrates that context mode or type in addition to a particular selected application may be gleaned to adjust biometric security levels according to predetermined requirements. Each application security level may differ depending on their purpose. For example, a banking application likely requires a higher security level than a conventional phone application. These differing security level adjustments for the applications are paired or coupled with the contextual information for the device. Some contextual modes may include data from a calendar entry, route location, and other contexts as well, such as time of day, ambient lighting conditions, elevation, environmental conditions, for example. These security level adjustments may result in realized time savings, energy savings, and reduced complexity.

A few use cases include the following:

### Example 1

Device calendar indicates user appointment at a certain time and location, when device is detected to match time/location, biometric ID requirement is reduced from high value to low value.

### Example 2

Device is in a low lighting condition making image recognition difficult. In this case, device recognizes bad lighting, looks at other sensors such as GPS to determine is user often is at such location, then temporarily reduces security level

### Example 3

User follows the same route between home and work, sensor accuracy is reduced when device is detected in this route

### Example 4

User is at home, reduce id accuracy down significantly (distinguishing between user and family members only)

### Example 5

Augment Example 1 above with hearing a user's voice within proximity to the phone the biometric ID security level is adjusted lower, because of a confidence that the user is present.

Additionally, a user's historical profile may be gleaned and used in addition to the contextual modes regarding their previous locations and usages associated with the electronic device 100.

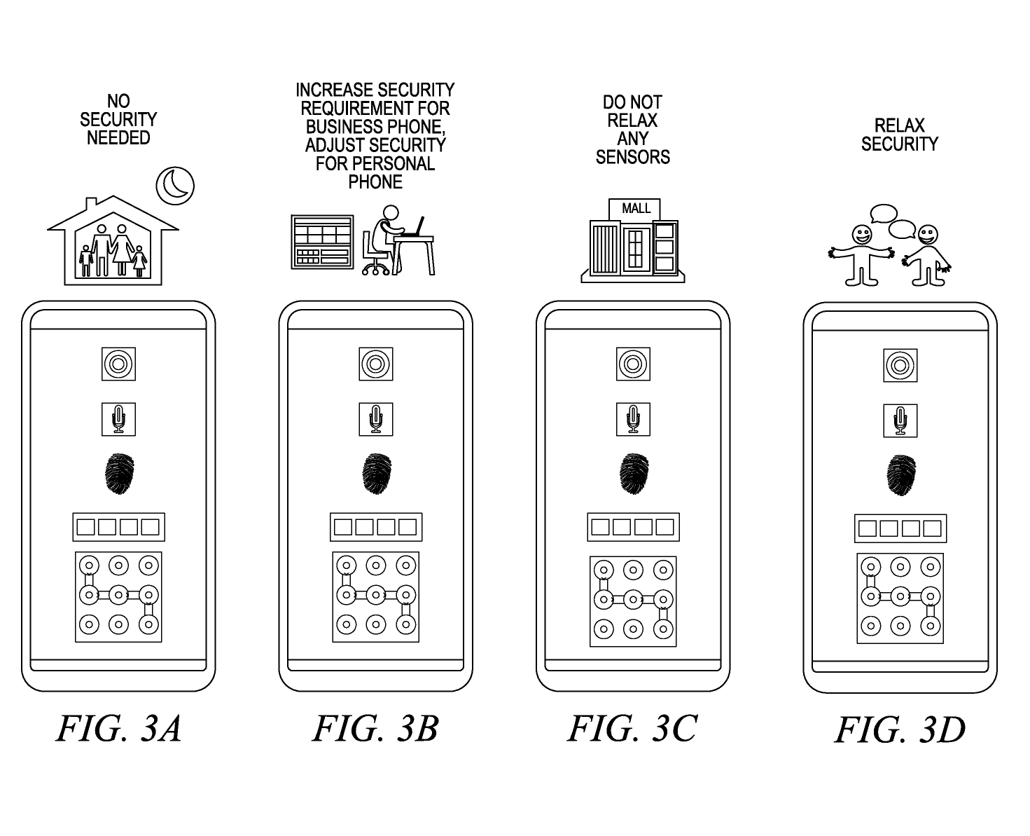

Referring to FIG. 3, several contextual modes are detectable by the electronic computing device 100. In some cases, the contextual modes are plural rather than singular. The electronic computer device 100, via its processor or controller, may then adjust the security levels to allow access to the device or increase security levels for greater difficulty in accessing the device or remove any security level where the contextual mode provides a level of confidence that the user is likely himself. Hence, a level of confidence has to be established for the electronic computing device 100.

FIG. 3 A has the device at home at night, therefore no security may be needed.

FIG. 3 B illustrates a calendar event that the device will be in a known office and security may be adjusted due to business needs for a business phone and security may also be adjusted to for a personal phone as well.

FIG. 3C shows that security level may be increased because of the traffic and amount of people present; therefore the sensors are not relaxed. In addition, restriction of access to certain data may be optional.

FIG. 3D shows that a conversation is ongoing and a voice pattern or print or identification is recognized from prior history or stored profile.

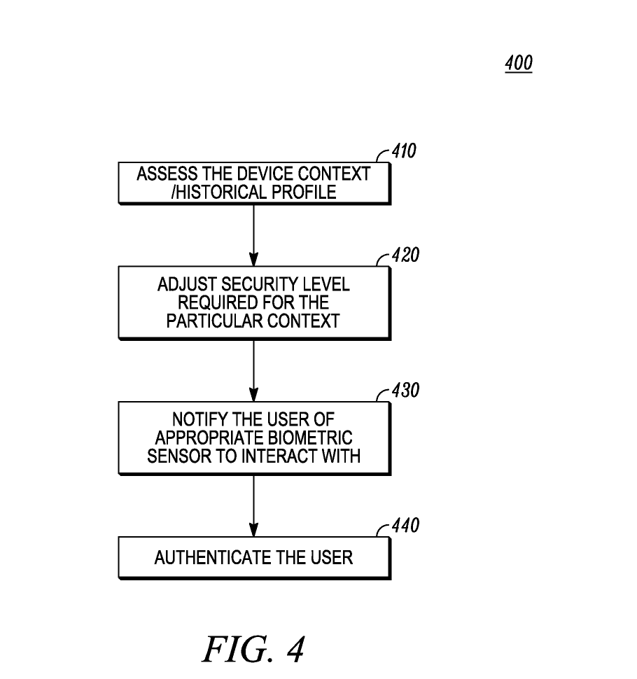

FIG. 4 illustrates example process 400 operations including assessing 410 the device context or user's historical profile (including a frequent location that the device is configured to sense via Wi-Fi, GPS, imaging sensors); adjusting 420 security level required for the identified device context and historical profile; notify 430 user of the biometric to be applied for best device/user interaction. Context may also be overridden by an operational mode or application. Authenticate 440 the user where it is possible, and grant the user access to the operational functionality of the device, including accessible features and applications.

Various sensor may need to be monitored to determine whether they have reached a predetermined threshold for a match comparison with the contextual mode or type. Thereafter, sensor accuracy may be relaxed or eliminate based on device context. The disclosed embodiment may advantageously eliminate time consuming, frustrating delays due to repeated authentication requests and/or rejections.

Security levels may be dynamically adjusted for one sensor output versus another sensor output. That is one sensor output may support a lower security level than another sensor output under the detected contextual conditions. Moreover, where two or more sensors exist, the security level corresponding to each sensor may each be lowered by a predetermined percentage, for example by 50 percent for each sensor.

The device context may comprise three different types as seen in the following use cases, including 1) user history at a certain location; such as user at home location at 11 PM (therefore, likely no authentication required, because of high confidence that user is authorized person); 2) user is at work with other people (therefore security level may be relaxed and a less reliable authentication sensor may be selected and used); user is at a crowded mall; therefore, no relaxation of security requirement, because of low level of confidence that holder of device is actual user (a more robust sensor may be employed for authentication).

Security level can be based on the type of application employed or selected for electronic computing device 100, such as email versus banking, or a social networking application or a camera application.

Based on device context, certain data in device may require different level of security than other stored data. For example, where the device is at work and an IT department partitions personal data from corporate data, a security level requirement may be relaxed for personal data when history shows location is commonplace. However, for corporate data the security level may be increase at work due to IT corporate policy and level of seniority in the department along with greater sensitive information. Confidence level may be impacted based on stored calendar inputs, location, and user history; hence confidence level settings may be dynamic and can employ other inputs such as voice inputs as well. For example, a confidence level and thereby ultimately a security level access may be dynamically adjusted based on additional criteria such as matching a calendar event to a location of the user as additional criteria. That is if a user is at a dentist office with his computing device and the internal calendaring application reflects a dentist appointment, then the confidence parameter is increased to reflect that the user of the device is most likely the authorized user and security level access may be dynamically adjusted lower. Other contextual data may also impact the lower security level access, including an initial or subsequent sensory input from a microphone or a biometric sensor such as a fingerprint sensor.

This disclosure also incorporates by reference in its entirety the teachings of U.S. Pat. No. 6,173,1740 filed on Nov. 30, 2012 by Alameh et al. and commonly assigned to Motorola Mobility LLC.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Likewise, computer-readable storage medium can comprise a non-transitory machine readable storage device, having stored thereon a computer program that include a plurality of code sections for performing operations, steps or a set of instructions.

Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for adjusting security levels for an electronic device based on confidence measurements, comprising:
monitoring contextual inputs from selectable contextual sensors communicatively coupled to the electronic device;
measuring a likelihood of an authorized user providing the user inputs;
establishing a confidence parameter for an authorized user; and
dynamically adjusting a security level for access to the electronic device based on the confidence parameter.

2. The method claimed in claim 1, further comprising
prioritizing a subset of authentication sensors based on device context.

3. The method claimed in claim 1, further comprising
dynamically adjusting the confidence parameters based on differing device applications and their corresponding security needs.

4. The method claimed in claim 1, wherein device context is at least one of a contextual detection mode including illumination, motion, weather, ambient noise, moisture, time of day, calendar/events, social network downloads, ambient temperature, elevation, location, speed, and obstructing clothing.

5. The method claimed in claim 4, further comprising developing a user history profile from one or more contextual detection modes.

6. The method claimed in claim 1, further comprising dynamically lowering sensors' security level for access to the electronic device independently based on device context.

7. The method claimed in claim 6, wherein at least one sensor is lowered to a different security than the other sensor.

8. The method claimed in claim 1, further comprising dynamically adjusting security level access based on context and data transmission.

9. A computing device enabled for reduction of false authorization rejections, comprising:
a housing;
a controller within said housing of the computing device for dynamically adjusting a security level access to the computing device based on confidence parameter developed from the computing device context;
a context sensor configured for analysis by the processor;
an authentication sensor and algorithm selectable by the processor based on detected context from the context sensor so that the authentication sensor is activated for user identity determination or device level access; and
a power module configured to provide power to the computing device, context sensor, and the authentication sensor.

13. The computing device according to claim 11 further comprising selection of the authentication sensor by the processor based on the authentication's sensor's estimated impact on at least one of the following: power savings, processor computational effort, and computing device operation.

14. The computing device according to claim 11, wherein the detected context is at least one of a contextual detection mode including illumination, time of day, calendar/event, motion, weather, ambient noise, moisture, ambient temperature, elevation, location, speed, historical user profile, and obstructing clothing.

15. The computing device according to claim 14 further comprising the controller configured to dynamically adjust the security level access with additional criteria comprised of a match of a calendar event to a location.

16. The method of claim 4 further comprising:
matching a calendar event to a location as additional criteria for dynamically adjusting the security level access.

17. The method of claim 1, further comprising:
overriding device context based on device operational mode and/or application.
